(19) United States
(12) Patent Application Publication
(10) Pub. No.: US 2014/0080019 A1
(43) Pub. Date: Mar. 20, 2014

(54) MONOCLINIC Sr1-xAxSi1-yGeyO3-0.5x, WHEREIN A IS K or Na, OXIDE ION CONDUCTOR

(71) Applicant: Board of Regents, The University of Texas System, Austin, TX (US)

(72) Inventors: John B. Goodenough, Austin, TX (US); Preetam Singh, Austin, TX (US)

(73) Assignee: Board of Regents, The University of Texas System, Austin, TX (US)

(21) Appl. No.: 13/965,930

(22) Filed: Aug. 13, 2013

Related U.S. Application Data
(60) Provisional application No. 61/747,084, filed on Dec. 28, 2012.
(60) Provisional application No. 61/702,405, filed on Sep. 18, 2012.

(51) Int. Cl. G01N 27/407; H01M 8/02; H01M 4/90; H01M 8/10

(52) U.S. Cl. CPC G01N 27/4073; H01M 8/1016; H01M 8/0236; H01M 4/9016
USPC 429/417; 429/495; 429/482; 204/424; 429/516; 502/242

(57) ABSTRACT

The disclosure provides a material with the general formula Sr₁₋ₓAₓSi_{1-y}Ge_{y}O_{3-0.5x}, wherein A is K or Na, including mixtures thereof, and wherein 0≦y≦1 and 0≦x≦0.4. In a specific embodiment, 0≦y≦0.5. In another specific embodiment, 0≦y≦0.1 and 0≦x≦0.4. In another specific embodiment 0.9≦y≦1 and 0≦x≦0.25. The material may be a single-phase polycrystalline solid having a monoclinic crystal structure. The material may have an oxide-ion conductivity (σₒ) greater than or equal to 10⁻² S/cm at a temperature of at least 500° C. The material may be formed into a planar or tubular membrane or a composite with another solid member. The material may be used as the electrolyte in a fuel cell or a regenerative or reverse fuel cell, as an oxygen sensor, or as an oxygen separation membrane. The material may also be used as a catalyst for oxidation of an olefin or for other purposes where oxide-ion conductivity is beneficial.

### PRIORITY CLAIM

This application claims priority under 35 U.S.C. §119 to U.S. Provisional Patent Application Ser. No. 61/747,084 filed Dec. 28, 2012 and U.S. Provisional Patent Application Ser. No. 61/702,405 filed Sep. 18, 2012. The contents of which is incorporated by reference herein in its entirety.

### TECHNICAL FIELD

The present disclosure relates to an oxide ion conducting material having the general formula Sr₁₋ₓAₓSi_{1-y}Ge_{y}O_{3-0.5x}, wherein A is K or Na, including mixtures thereof. The Sr₁₋ₓAₓSi_{1-y}Ge_{y}O_{3-0.5x} material may be synthesized in solid form. The present disclosure also relates to solid oxide ion electrolytes containing such a material and to fuel cells containing such electrolytes, such as solid oxide fuel cells.

### BACKGROUND

Fuel cells convert the chemical energy from the reaction of a fuel, such as hydrogen or a hydrocarbon gas, with oxygen in the air into electrical energy. This electrical energy is compatible with existing electrical systems, such as systems that run off batteries or household electricity. For example, electrical energy generated with a fuel cell may be used to supplement the electrical energy fed to the grid by a power plant, to charge batteries that power consumer portable devices or to power directly generators and automobiles.

Fuel cells operating on hydrogen are environmentally friendly because the primary by-product of their operation is simply water. Although fuel cells that use hydrocarbons instead of hydrogen gas also produce carbon dioxide as a by-product, the amount produced is considerably less than what is produced by more traditional methods of extracting energy from hydrocarbons, such as coal-fired power plants and the internal combustion engine.

Fuel cells able to use hydrocarbon fuels, instead of merely hydrogen gas, are of great interest for a variety of reasons, including their ability to rely on existing energy supply chains and their flexibility in fuel sources. One common type of fuel cell able to use a wide variety of hydrocarbon fuels is the solid oxide fuel cell. However, due to the materials available for use in these fuel cells, they operate today at very high temperatures, typically 800° C. or higher. Specifically, in traditional solid oxide fuel cells, the electrolyte is made from yttria-stabilized zirconia (YSZ). YSZ only exhibits acceptable oxide ion conductivity at temperatures above 800° C., typically 800° C. to 1000° C. At lower temperatures, oxide ion conductivity becomes too low. In some newer cells using an electrolyte material with the general formula La₁₋ₓSrₓGa_{1-y}Mg_{y}O_{3-0.5(x+y)} (LSGM), oxide ion conductivity may be acceptable at temperatures as low as 600° C., but this electrolyte has a problem with the electrode-electrolyte reaction.

Accordingly, there is a need for solid oxide fuel cells able to operate effectively at lower temperatures. Additionally, there is a need for solid oxide fuel cells containing alternative components to allow further flexibility in raw materials used to produce such cells, manufacturing processes, and ultimate uses of fuel cells.

### SUMMARY

The present disclosure provides a material with the general formula Sr₁₋ₓAₓSi_{1-y}Ge_{y}O_{3-0.5x}, wherein A is K or Na, including mixtures thereof, and wherein 0≦y≦1 and 0≦x≦0.4. In a more specific embodiment, 0≦y≦0.5. In another specific embodiment, 0≦y≦0.1 and 0≦x≦0.4. In another specific embodiment 0.9≦y≦1 and 0≦x≦0.25.

The material may be in the form of a single-phase polycrystalline solid having a monoclinic crystal structure. The material may have an oxide-ion conductivity (σₒ) greater than or equal to 10⁻² S/cm at a temperature of at least 500° C. The material may be formed into a planar or tubular membrane, such as a tube that separates the fuel flow from the oxygen flow in a fuel cell.

The material may be used as the electrolyte in a fuel cell or a regenerative or reverse fuel cell, as an oxygen sensor, or as an oxygen separation membrane. The material may also be used as a catalyst for oxidation of an olefin. The material may have other uses in applications where oxide-ion conductivity is beneficial.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments of the present invention may be better understood through reference to the following figures in which:

FIG. 1A illustrates the basic components and reactions of a solid oxide fuel cell operating in H₂ gas;

FIG. 1B illustrates the chemical reactions taking place in and movement of hydrogen fuel, oxygen gas, electrons and oxide-ions in a solid oxide fuel cell;

FIG. 2 illustrates a material with the general formula SrSi_{1-y}Ge_{y}O_{3-0.5x} and a monoclinic crystal structure also applicable to a material with the general formula Sr₁₋ₓAₓSi_{1-y}Ge_{y}O_{3-0.5x}, wherein A is K or Na, including mixtures thereof;

FIG. 3A provides X-ray diffraction (XRD) patterns from a material with the general formula Sr₁₋ₓKₓSiO_{3-0.5x}, where 0.1≦x≦0.3;

FIG. 3B provides XRD patterns from a material with the general formula Sr₁₋ₓKₓGeO_{3-0.5x}, where 0≦x≦0.25, (*)denotes peaks for Sr₂SiO₄ phase;

FIG. 3C provides XRD patterns from a material with the general formula Sr₁₋ₓNaₓSiO_{3-0.5x}, where 0≦x≦0.4;

FIG. 4A shows the Rietveld refinement of the XRD profile of Sr_{0.8}K_{0.2}SiO_{2.9};

FIG. 4B shows the Rietveld refinement of the XRD profile of Sr_{0.85}K_{0.15}GeO_{2.925};

FIG. 4C shows the Rietveld refinement of the XRD profile of Sr_{0.8}K_{0.2}Si_{0.5}Ge_{0.5}O_{2.9};

FIG. 5A shows an SEM micrograph of Sr_{0.8}K_{0.2}Si_{0.5}Ge_{0.5}O_{2.9} from powder;

FIG. 5B shows an SEM micrograph of Sr_{0.8}K_{0.2}Si_{0.5}Ge_{0.5}O_{2.9} from pellet;

FIG. 5C shows an EDX profile of Sr_{0.8}K_{0.2}Si_{0.5}Ge_{0.5}O_{2.9};

FIG. 6A shows an SEM micrograph of Sr_{0.8}K_{0.2}SiO_{2.9} from powder;

FIG. 6B shows an SEM micrograph of Sr_{0.8}K_{0.2}SiO_{2.9} from a pellet;

FIG. 6C shows an EDX profile of Sr_{0.8}K_{0.2}SiO_{2.9};

FIG. 7A shows an SEM micrograph of Sr_{0.85}K_{0.15}GeO_{2.925} from powder;

FIG. 7B shows an SEM micrograph of Sr_{0.85}K_{0.15}GeO_{2.925} from a pellet;

FIG. 7C shows an EDX profile of Sr_{0.85}K_{0.15}GeO_{2.925};

FIG. 8A shows an Arrhenius plot for various materials of the general formula Sr₁₋ₓKₓSi_{1-y}Ge_{y}O_{3-0.5x};

FIG. 8B shows an Arrhenius plot for other materials of the general formula Sr₁₋ₓKₓSi_{1-y}Ge_{y}O_{3-0.5x};

FIG. 8C shows an Arrhenius plot for other materials of the general formula Sr₁₋ₓNaₓSiO_{3-0.5x};

FIG. 9A shows a complex impedance spectrum of Sr_{0.8}K_{0.2}Si_{0.5}Ge_{0.5}O_{2.9} at 800° C.;

FIG. 9B shows a complex impedance spectrum of Sr_{0.8}K_{0.2}Si_{0.5}Ge_{0.5}O_{2.9} at 700° C.;

FIG. 9C shows a complex impedance spectrum of Sr_{0.8}K_{0.2}Si_{0.5}Ge_{0.5}O_{2.9} at 600° C.;

FIG. 9D shows a complex impedance spectrum of Sr_{0.8}K_{0.2}Si_{0.5}Ge_{0.5}O_{2.9} at 500° C.

### DETAILED DESCRIPTION

The present disclosure relates to an oxide ion conducting material having the general formula Sr₁₋ₓAₓSi_{1-y}Ge_{y}O_{3-0.5x}, wherein A is K or Na, including mixtures thereof. The Sr₁₋ₓAₓSi_{1-y}Ge_{y}O_{3-0.5x} material may be in a solid form and have a monoclinic crystal structure. The present disclosure also relates to electrolytes containing such a material and to fuel cells containing such electrolytes, such as solid oxide fuel cells. Such a fuel cell may be operable at temperatures below those used in connection with conventional electrolyte materials.

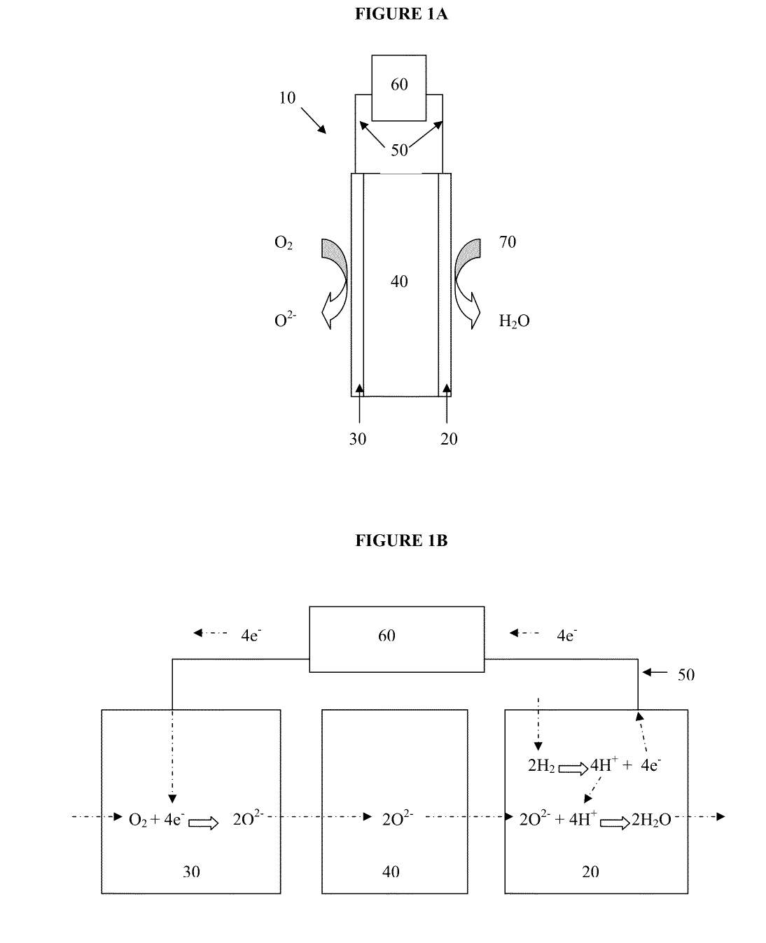

FIG. 1A illustrates a solid oxide fuel cell 10. Solid oxide fuel cell 10 contains an anode 20, a cathode 30 and an electrolyte 40. Solid oxide fuel cell 10 also contains leads 50, which may be connected to a device powered by the fuel cell 60.

When solid oxide fuel cell 10 is in operation, three chemical reactions take place, typically at the same time or nearly the same time. These chemical reactions and the movement of participants in these reactions are further illustrated in FIG. 1B. With hydrogen gas as fuel, hydrogen (H) from a fuel source 70 reacts with the anode to form hydrogen ions (H⁻) and free electrons (e⁻). These free electrons move through the leads 50 to the cathode, powering device 60 in the process. Oxygen (O₂) in the air reacts with cathode 30 to accept four free electrons (e⁻) from leads 50 to form two oxide ions (O²⁻). The oxygen ions enter the electrolyte 40. Electrolyte 40 is able to conduct oxide ions. Thus, when two oxide ions enter electrolyte 40 at the cathode, two oxide ions are able to leave electrolyte 40 at the anode. These oxide ions at the anode react with the hydrogen ion already at the anode in the third chemical reaction taking place in the fuel cell to form water.

The present disclosure provides an oxide ion conductive material that may be used in electrolyte 40. This material has the general formula Sr₁₋ₓAₓSi_{1-y}Ge_{y}O_{3-0.5x}, wherein A is K or Na, including mixtures thereof. In specific embodiments, 0≦y≦1, more specifically 0≦y≦0.5. In one specific embodiment, 0≦x≦0.3 when A is K. In a more specific embodiment, 0≦y≦0.1 and 0≦x≦0.3 where A is K. In another more specific embodiment, 0.9≦y≦1 and 0≦x≦0.25 when A is K. Also in specific embodiments 0≦x≦0.4 where A is Na. In a more specific embodiment, 0≦y≦0.1 and 0≦x≦0.4 where A is Na. In another more specific embodiment, 0.9≦y≦1 and 0≦x≦0.25 where A is Na. Furthermore, in some embodiments, Ge may be wholly or partially substituted with another element, such as B.

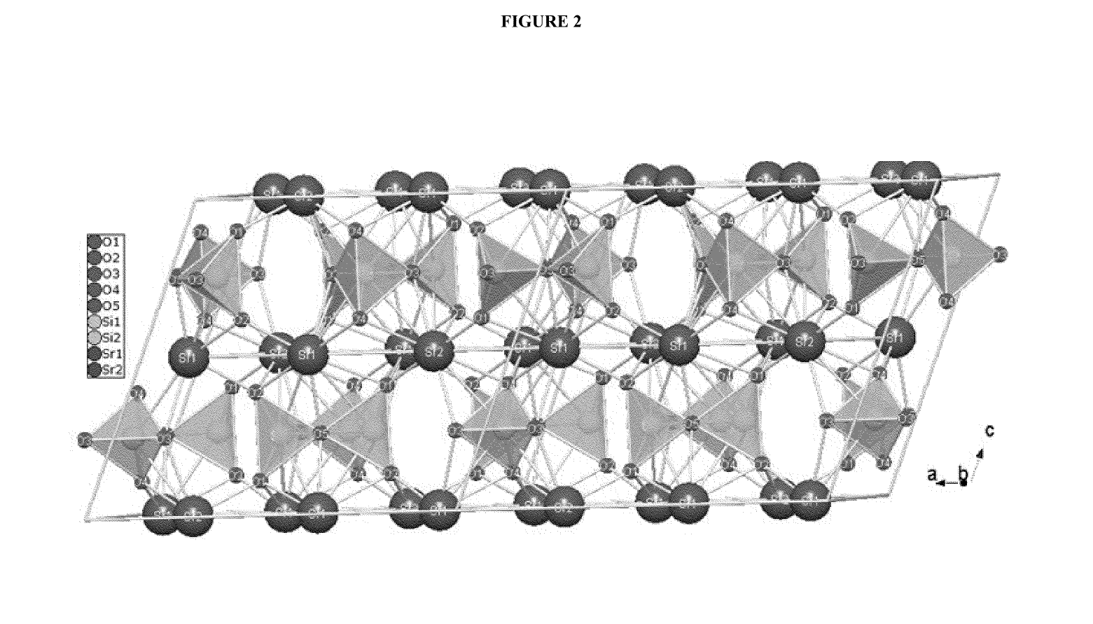

The material may further have a monoclinic crystal structure, space group C12/c1. An example of this crystal structure for a material having the formula SrSi_{1-y}Ge_{y}O_{3-0.5x} is shown in FIG. 2. One of ordinary skill in the art will understand that, in material with the formula Sr₁₋ₓAₓSi_{1-y}Ge_{y}O_{3-0.5x}, wherein A is K or Na, including mixtures thereof, Sr will be replaced with A in some locations shown in FIG. 2. The chemical formula Sr₁₋ₓAₓSi_{1-y}Ge_{y}O_{3-0.5x} may be adjusted such that a single phase crystalline solid is formed. This material may exhibit an oxide-ion conductivity (σₒ) greater than or equal to 10⁻² S/cm in a temperature range of at least 500° C., for example 500° C. to 700° C.

Without limiting the invention to a particular theory, monoclinic Sr₁₋ₓKₓSi_{1-y}Ge_{y}O_{3-0.5x} may exhibit acceptable oxide ion conductivity due to the presence of either a terminal oxygen vacancy or an interstitial oxide-ion. The presence of this oxide-ion vacancy or interstitial oxide-ion may be understood by first considering its location in the tetrahedral SrMO₃ complex, wherein M is Si or Ge. This SrMO₃ complex contains (001) planes of isolated M₃O₉ units of three MO₄ complexes in which each MO₄ unit shares corners with two other tetrahedra of the M₃O₉ unit. These units lie within the a-b planes that are separated from one another by a close-packed layer of large Sr²⁺ ions, each coordinated above and below by three terminal coplanar oxide ions belonging to three different M₃O₉ units.

Substitution of K⁺ or Na⁺ for Sr²⁺ in a material having the general formula Sr₁₋ₓAₓSi_{1-y}Ge_{y}O_{3-0.5x}, wherein A is K or Na, including mixtures thereof, introduces terminal-oxygen vacancies. If these are not accommodated by corner sharing with a neighboring M₃O₉ unit, due to steric hindrance by the large Sr²⁻ and A⁺ ions, a terminal oxygen vacancy would be expected to jump between clusters following generally the double well potential model. This movement may be similar to that of a proton in an asymmetric hydrogen bond in an alkaline solution.

Alternatively, again without limiting the invention to a particular theory, oxide ion conductivity may result from introduction of interstitial oxygen resulting from distortions of the M₃O₉ unit to obtain corner sharing that eliminates the oxygen vacancy.

Electrolyte 40 in fuel cell 10 may contain, in addition to the monoclinic Sr₁₋ₓAₓSi_{1-y}Ge_{y}O_{3-0.5x} material described above, other components, such as additional electrolytes, materials to stabilize the solid crystalline material in the fuel cell, binders and any other components suitable for addition to solid oxide-ion conducting materials. Electrolyte 40 may include the monoclinic Sr₁₋ₓAₓSi_{1-y}Ge_{y}O_{3-0.5x} material in the form of particles such as microparticles nanoparticles, or pellets containing a plurality of particles. For example, the material may be in the form of a porous solid formed from powder. Powder may be in the form of grains 2-10 μm in size. The porous solid may having connected grains of powder. For example, it may be a ceramic with connected grains that may contain pores. Pellets may be sintered. Pellets may contain grains of powder, which may be in contact with one another. Pellets may also contain binders, sintering materials and other components.

In one embodiment, electrolyte 40 may be formed as a planar or tubular membrane or other solid member able to block the passage of electrons within the electrolyte between the anode and the cathode. For example, the membrane or other solid member may include a tube that separates the fuel flow from the oxygen flow in a fuel cell. The membrane or other solid member may contain a non-electrolyte material. Such material may provide structural support or integrity to the membrane or other solid material. Such material may include a binder, such as a polymer. The membrane or solid member may be an electronic insulator.

Anode 20 may contain any material suitable to cause the removal of electrons from hydrogen or a hydrocarbon fuel to result in hydrogen ions and free electrons. For example, anode 20 may include any material suitable for use in other solid oxide fuel cells. In one embodiment, anode 20 may include a catalytic material able to catalyze the formation of absorbed hydrogen and or carbon ions from hydrogen gas or a hydrocarbon fuel. The catalytic material or another additive material in the anode may also be electrically conductive.

In one embodiment, the anode 20 may include a cermet (ceramic metal) material, such as a nickel-based cermet material. The ceramic portion of the anode may include one or more materials also found in the electrolyte.

Fuel 70 may be hydrogen or a hydrocarbon gas. If the hydrocarbon fuel is methane, propane, or butane, in some embodiments, it may simply be supplied to the anode and able to react with the anode without prior processing. If the hydrocarbon fuel is a more complex fuel, such as gasoline, diesel, or a biofuel, it may be processed in or near the fuel cell, prior to or at the same time as contact with the anode to facilitate its interaction with the anode to produce hydrogen ions. For example, the hydrocarbon fuel may be reformed.

Cathode 30 may contain any material suitable to cause the addition of electrons to oxygen gas in the air to form absorbed oxide ions. For example, cathode 30 may include a catalytic material able to catalyze the formation of oxide ions. The catalytic material or other additive material may also be electrically conductive.

In one embodiment, the cathode 30 may contain a lanthanum manganite, particularly a lanthanum or rare-earth manganite doped with an alkaline element (e.g. Sr) to increase its electrical conductivity, such as lanthanum-strontium manganite. Cathode 30 may also contain other air-reactive materials, such as mixed electronic/oxide-ion conductors.

Anodes and cathodes may both be formed as porous structures to facilitate the movement of fuel, air, water, carbon dioxide, or other wastes through the electrode. Anodes and cathodes may have microstructures designed to facilitate catalytic activity or overall fuel-cell performance. Anodes and cathodes may include binders and conductive additives. In any fuel cell, anode 20 and cathode 30 may be either directly or indirectly (e.g. through conductive backing) in electrical contact with leads 50.

Anode 20, cathode 30 and electrolyte 40 must function within certain compatible electrochemical parameters to form a functional fuel cell. Furthermore, the choice of different anodes/electrolyte/cathode combinations may affect an electrical parameter of the fuel cell, such as power or power density. The chosen combination may also affect other performance parameters, such as compatible fuels, suitable operating conditions, and usable life. In one embodiment, a longer-life fuel cell or a fuel cell less easily damaged by its environment may be created by avoiding the use of platinum or similar noble metals as a catalyst material. Fuel cells using an electrolyte of the present invention may also allow the use of catalyst materials in the anode or the cathode that are not usable in many present solid oxide fuel cells due to incompatibilities with the higher temperatures at which such cells operate.

A fuel cell 10 of the present disclosure may be formed in a wider variety of shapes than fuel cells that contain liquid electrolytes. In one embodiment they may be in a generally tubular shape, allowing the flow of fuel through the inside and air through the outside or vice versa. In another embodiment, fuel cells may be stacked and may contain an interconnect layer of conductive material to allow them to be electrically connected.

In general, due to the relatively low voltage generated by most fuel cells, they may be electrically connected in series to allow increased voltage from a system containing multiple fuel cells.

The reactions that result in water in a fuel cell are exothermic. A fuel cell 10 of the present disclosure may be configured to allow use of this heat for other processes connected to fuel cell operation. Similarly, a fuel cell 10 of the present disclosure may be configured to allow use of by-product water for other processes connected to fuel cell operation. The solid oxide fuel cell may also be configured into a rechargeable battery by addition of a redox chamber.

In addition to the uses described above in connection with fuel cells, the monoclinic Sr₁₋ₓAₓSi_{1-y}Ge_{y}O_{3-0.5x} material, wherein A is K or Na, including mixtures thereof, described herein may also be used in any other application where oxide ion conductivity is needed.

In one embodiment, the material may be used in an oxygen sensor, particularly in an oxygen sensor designed for sensing in a high temperature environment, such as in molten metals. This type of oxygen sensor may be particularly useful in connection with industrial steel production.

In another embodiment, the material may be used in an oxygen separation membrane.

In another embodiment, the material may be used in a regenerative fuel cell or reverse fuel cell (RFC), which is a fuel cell run in reverse mode, thereby consuming electricity and chemical B to produce chemical A (e.g. A regenerative hydrogen fuel cell uses electricity and water to produce hydrogen and oxygen).

In still another embodiment, the material may be used as a catalyst for the partial oxidation of olefins, which is a component of many industrial processes.

In a further embodiment, the material may be used as a membrane in hydrogen production from steam electrolysis.

Additional embodiments may use the material in microelectronics.

### EXAMPLES

The present invention may be better understood through reference to the following examples. These examples are included to describe exemplary embodiments only and should not be interpreted to encompass the entire breadth of the invention.

Sr₁₋ₓKₓMO_{3-0.5x}, wherein M is Si or Ge, samples were synthesized by solid-state reaction from a stoichiometric amount of mixed SrCO₃, K₂CO₃ and SiO₂ or GeO₂ powders heated at 1150° C. when M was Si (M=Si) or at 1050° C. when M was Ge for 15 h. Sr₁₋ₓKₓSi_{1-y}Ge_{y}O_{3-0.5x} samples were synthesized by solid-state reaction from a stoichiometric amount of mixed SrCO₃, K₂CO₃ and SiO₂ or GeO₂ powders heated at 1100° C. for 15 h. Sr₁₋ₓNaₓSiO_{3-0.5x} samples were synthesized by solid-state reaction from a stoichiometric amount of mixed SrCO₃, Na₂CO₃ and SiO₂ powders heated at 1100° C., for 20 h. The dry samples were obtained by slow furnace cooling to room temperature. For conductivity measurements, the resulting powders were made into pellets (typically ˜0.2 cm in thickness and ˜1 cm in diameter) by pressing the powder with 1 weight % of Polyvinyl butyral (PVB) at 5 GPa and firing at 1050° C. when M was Si, at 950° C. when M was Ge, and at 1000° C. when M was Si and Ge or when M was Si and A was Na, for 20 h.

The phase purity of the compounds was confirmed by powder X-ray diffraction (PXRD) with a Philips X'pert diffractometer (Cu Kα radiation, λ=1.5418 Å) in Bragg-Brentano reflection geometry. A Rietveld structure refinement was carried out with the Fullprof program and the monoclinic SrSiO₃ (C12/c1) model; the required quantities of K ions were placed at Sr sites and Ge at Si sites. Microstructure (shape and surfaces) of the powder and pellets were examined with a scanning electron microscope at an accelerating voltage of 20 kV (SEM, JEOL, JSM-5610). The composition of the compounds was confirmed by Energy-dispersive X-ray (EDX) spectroscopy with a probe attached to the SEM instrument.

Two-probe AC impedance measurements of oxide-ion conductivity (σₒ) were made with a Solartron Impedance Analyzer (model 1287) (Hampshire, UK) operating in the range of frequency from 1 Hz to 10 MHz with an AC amplitude of 10 mV. Two Pt blocking electrodes were made by coating Pt paste (Heraeus, South Bend, Ind.) on the two faces of the pellets and baking at 800° C. for 1 h. All measurements were made on cooling from 800° C. down to 400° C.

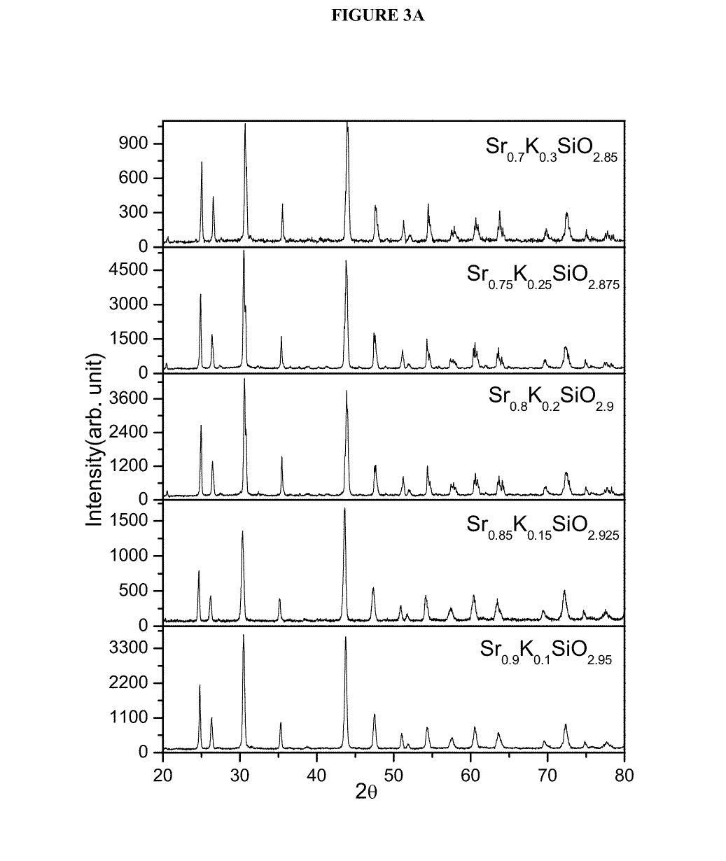

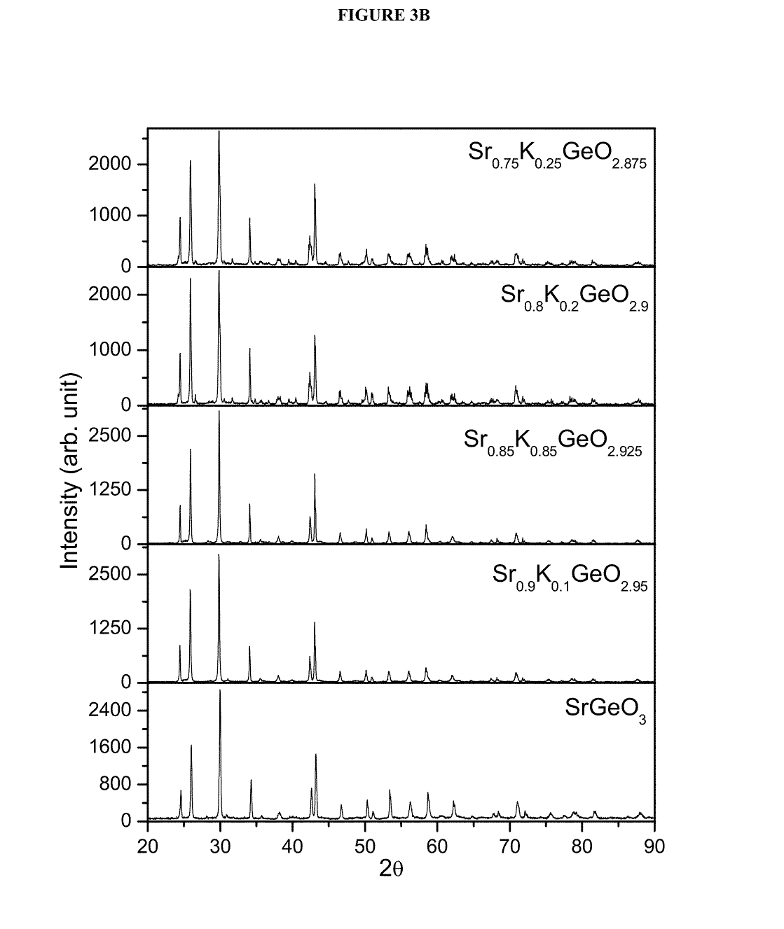

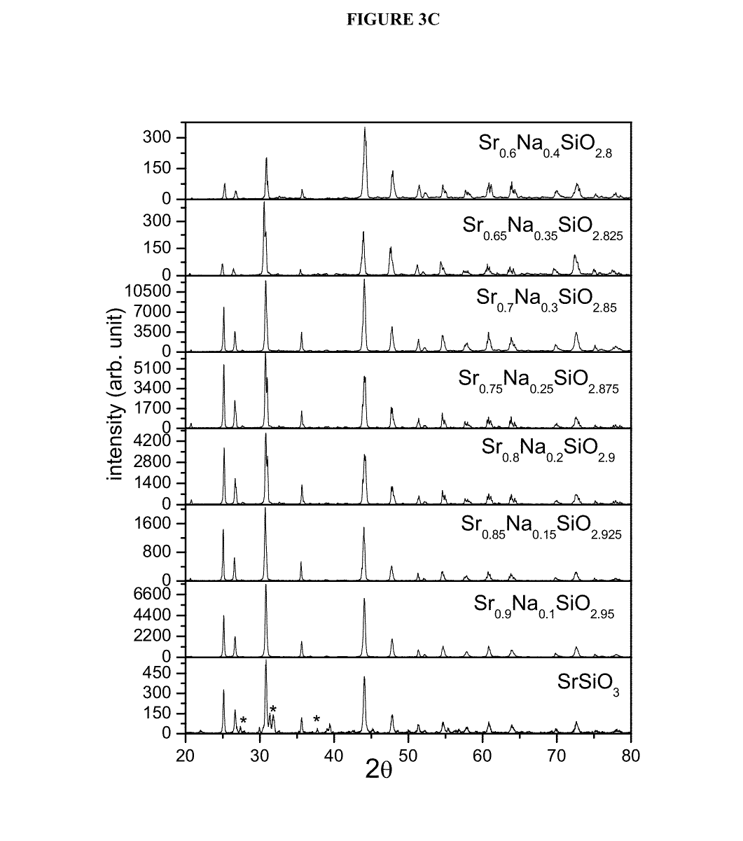

The powder XRD patterns showed that the Sr₁₋ₓAₓMO_{3-0.5x} samples were single-phase in the interval 0.1≦x≦0.3 when A was K and M was Si (FIG. 3A), in the interval 0≦x≦0.25 when A was K and M was Ge (FIG. 3B) and in the interval 0.10≦x≦0.4 when A was Na and M was Si (FIG. 3C). Without substitution of K or Na, SrSiO₃ did not from a single phase. SrSiO₃ and SrGeO₃ phases were completely soluble in each other and up to 50% Ge could be substituted for Si in Sr₁₋ₓKₓSi_{1-y}Ge_{y}O_{3-0.5x}.

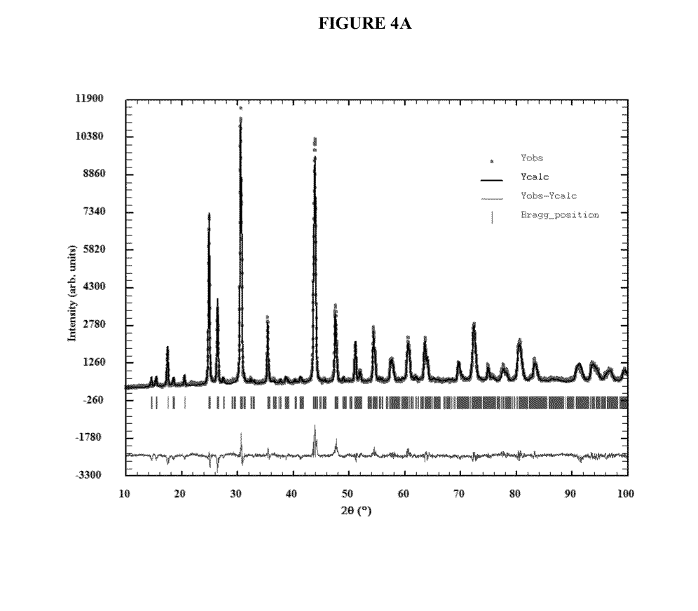

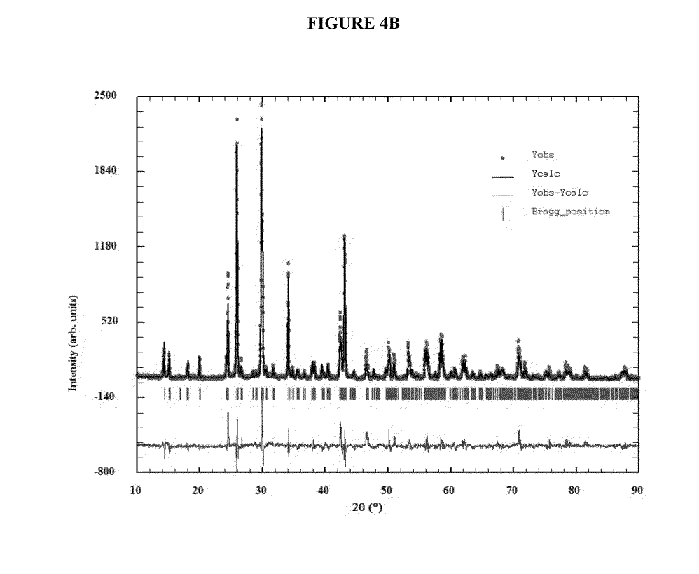

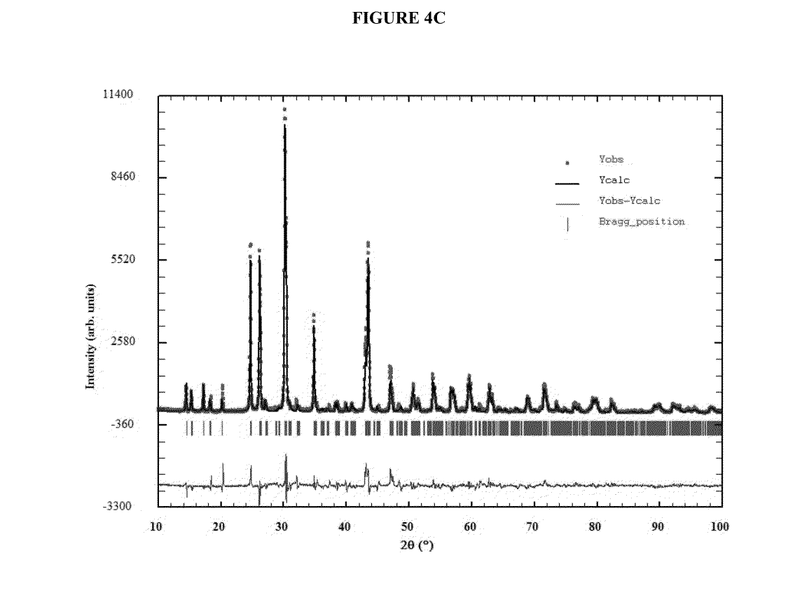

FIG. 4 shows the Rietveld refinement of the XRD profile of Sr_{0.8}K_{0.2}SiO_{2.9} (FIG. 4A), Sr_{0.85}K_{0.15}GeO_{2.925} (FIG. 4B) and Sr_{0.8}K_{0.2}Si_{0.5}Ge_{0.5}O_{2.9} (FIG. 4C). The fitted profiles match the observed XRD patterns well. The structural parameters obtained from the Rietveld refinement of the powder XRD patterns are given in TABLES 1 and 2.

TABLE 1
Lattice parameters of Sr₁₋ₓAₓSi_{1-y}Ge_{y}O_{3-0.5x}

| | Lattice parameter (Å) | | | |
|---|---|---|---|---|
| Compound | (a) | (b) | (c) | β |
| Sr_{0.9}K_{0.1}SiO_{2.95} | 12.362 (1) | 7.1435 (5) | 10.9072 (3) | 111.80 (1) |
| Sr_{0.85}K_{0.15}SiO_{2.925} | 12.367 (1) | 7.1439 (6) | 10.9089 (8) | 111.77 (1) |
| Sr_{0.8}K_{0.2}SiO_{2.9} | 12.349 (1) | 7.1528 (3) | 10.9023 (3) | 111.66 (1) |
| Sr_{0.75}K_{0.25}SiO_{2.875} | 12.3464 (5) | 7.1523 (3) | 10.8934 (3) | 111.61 (1) |
| Sr_{0.9}Na_{0.1}SiO_{2.95} | 12.5633 (2) | 7.2741 (5) | 11.2735 (3) | 111.30 (1) |
| Sr_{0.85}Na_{0.15}SiO_{2.925} | 12.3576 (6) | 7.1421 (6) | 10.9104 (8) | 111.32 (1) |
| Sr_{0.8}Na_{0.2}SiO_{2.9} | 12.3489 (4) | 7.1555 (2) | 10.8973 (3) | 111.57 (1) |
| Sr_{0.75}Na_{0.25}SiO_{2.875} | 12.3435 (7) | 7.1531 (3) | 10.8935 (2) | 111.57 (1) |
| Sr_{0.7}Na_{0.3}SiO_{2.85} | 12.3571 (8) | 7.1499 (4) | 10.9092 (4) | 111.72 (1) |
| SrSiO₃ | 12.333 (2) | 7.146 (1) | 10.885 (1) | 111.57 (1) |
| Sr_{0.9}K_{0.1}GeO_{2.95} | 12.5633 (2) | 7.2741 (5) | 11.2735 (3) | 111.30 (1) |
| Sr_{0.85}K_{0.15}GeO_{2.925} | 12.5661 (5) | 7.2737 (3) | 11.2771 (5) | 111.31 (1) |
| Sr_{0.8}K_{0.2}GeO_{2.9} | 12.5691 (2) | 7.2731 (1) | 11.2803 (3) | 111.32 (1) |
| SrGeO₃ | 12.5333 (3) | 7.262 (1) | 11.259 (3) | 111.30 (2) |
| Sr_{0.8}K_{0.2}Si_{0.6}Ge_{0.4}O_{1.9} | 12.4316 (7) | 7.2007 (4) | 11.1011 (1) | 112.48 (1) |
| Sr_{0.8}K_{0.2}Si_{0.5}Ge_{0.5}O_{1.9} | 12.4546 (7) | 7.2131 (4) | 11.1379 (6) | (112.43) 1 |

TABLE 2
Structural parameters of Sr₁₋ₓAₓSi_{1-y}Ge_{y}O_{3-0.5x}

| | Cell Volume | | | | |
|---|---|---|---|---|---|
| Compound | (Å³) | χ² | R_{f} | R_{Bragg} | R_{wp} |
| Sr_{0.9}K_{0.1}SiO_{2.95} | 894.30 | 2.72 | 6.18 | 8.41 | 19.5 |
| Sr_{0.85}K_{0.15}SiO_{2.925} | 894.88 | 1.85 | 6.43 | 9.04 | 23.5 |
| Sr_{0.8}K_{0.2}SiO_{2.9} | 895.02 | 5.37 | 5.81 | 8.45 | 15.2 |
| Sr_{0.75}K_{0.25}SiO_{2.875} | 894.55 | 4.17 | 8.36 | 10.8 | 20.1 |
| Sr_{0.9}Na_{0.1}SiO_{2.95} | 1030.25 | 3.57 | 8.97 | 14.2 | 29.6 |
| Sr_{0.85}Na_{0.15}SiO_{2.925} | 893.97 | 2.49 | 7.54 | 7.99 | 25.5 |
| Sr_{0.8}Na_{0.2}SiO_{2.9} | 895.48 | 2.73 | 4.72 | 7.12 | 15.4 |
| Sr_{0.75}Na_{0.25}SiO_{2.875} | 894.48 | 5.01 | 7.05 | 9.42 | 18.5 |
| Sr_{0.7}Na_{0.3}SiO_{2.85} | 895.43 | 3.5 | 7.21 | 9.86 | 23.6 |
| SrSiO₃ | 892.12 | | | | |
| Sr_{0.9}K_{0.1}GeO_{2.95} | 1030.25 | 3.57 | 8.97 | 14.2 | 29.6 |
| Sr_{0.85}K_{0.15}GeO_{2.925} | 1030.75 | 3.27 | 8.42 | 12.4 | 26.2 |
| Sr_{0.8}K_{0.2}GeO_{2.9} | 1031.30 | 3.45 | 8.42 | 13.7 | 26.7 |
| SrGeO₃ | 1024.76 | | | | |
| Sr_{0.8}K_{0.2}Si_{0.6}Ge_{0.4}O_{1.9} | 918.21 | 4.83 | 7.44 | 10.8 | 24.1 |
| Sr_{0.8}K_{0.2}Si_{0.5}Ge_{0.5}O_{1.9} | 924.86 | 11.4 | 12.0 | 7.9 | 23.9 |

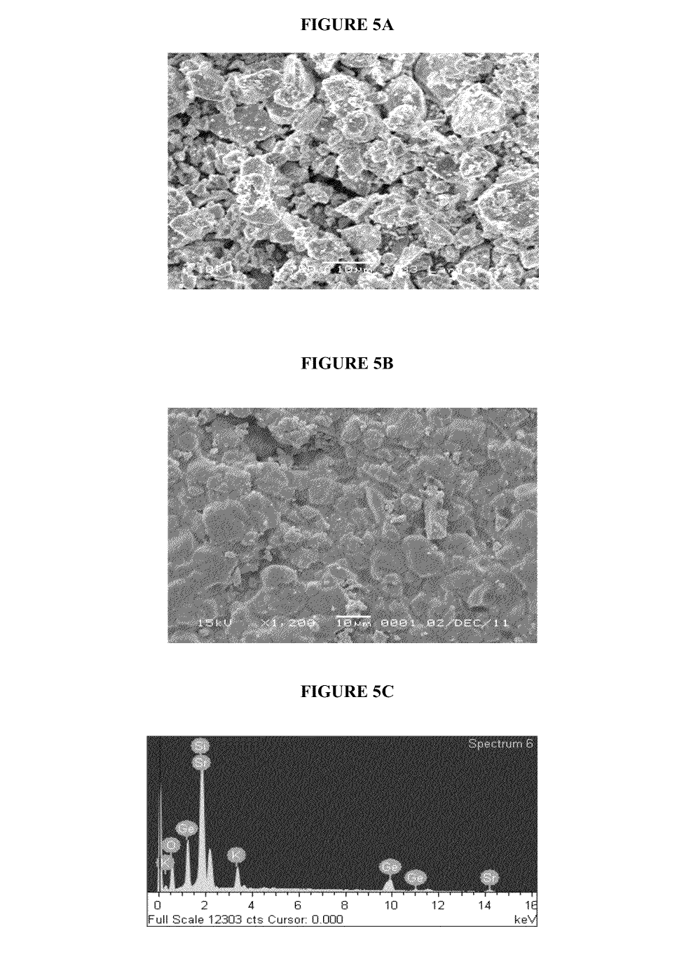

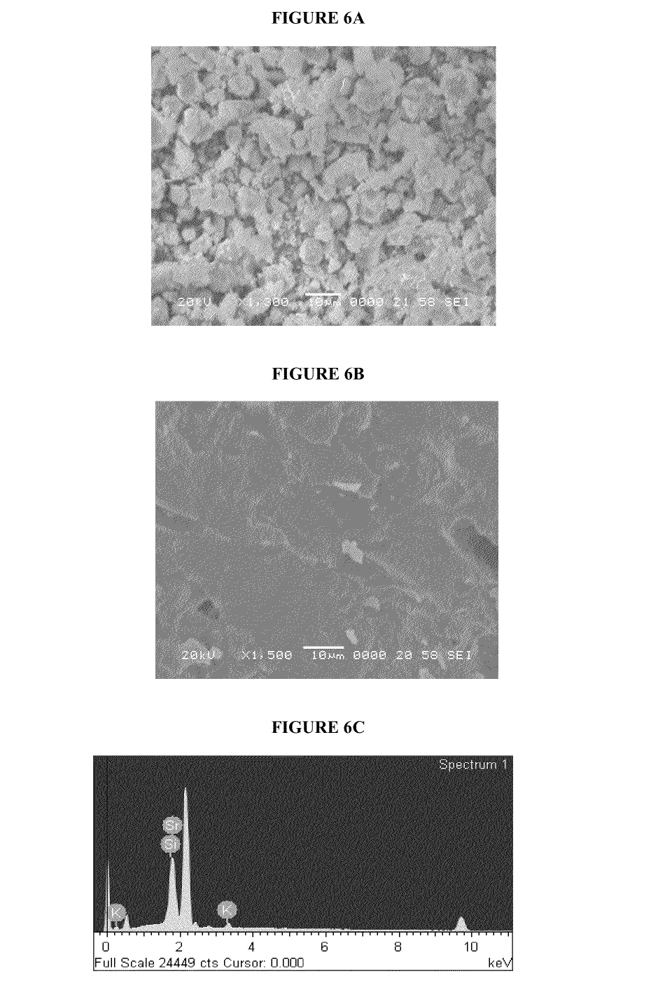

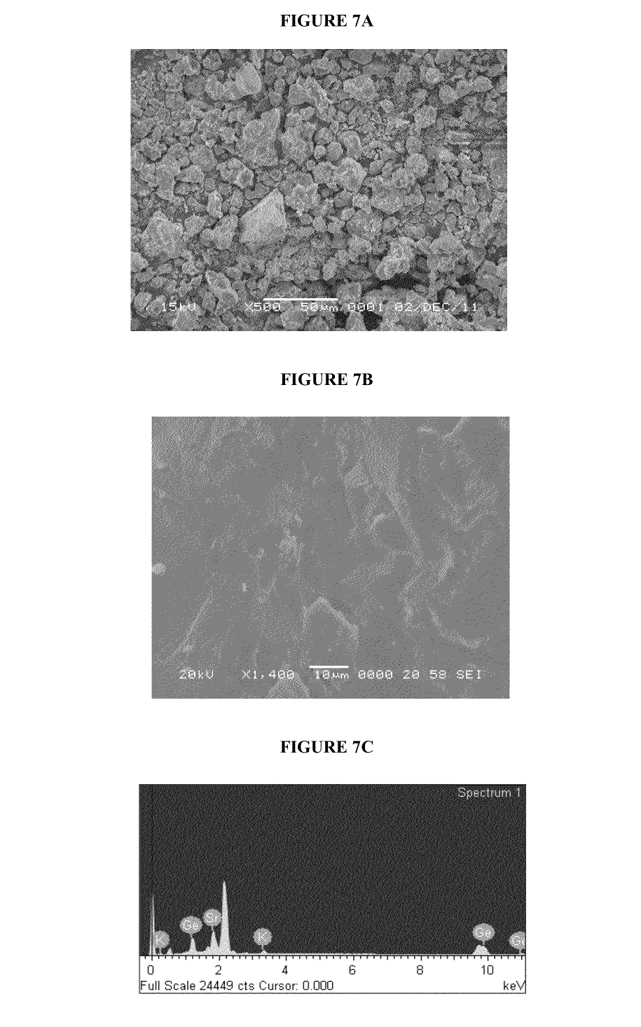

Sr₁₋ₓKₓSi_{1-y}Ge_{y}O_{3-0.5x} samples were analyzed by EDX. SEM micrographs and the EDX profile of Sr_{0.8}K_{0.2}Si_{0.5}Ge_{0.5}O_{2.9} (powder and pellet used for conductivity measurement) are provided in FIGS. 5A-C. SEM micrographs and EDX profiles of Sr_{0.8}K_{0.2}SiO_{2.9} and Sr_{0.85}K_{0.15}GeO_{2.925} (powder and pellet) are provided in FIG. 6 and FIG. 7, respectively. The SEM study revealed that the powders were porous with grains of 2-10 μm in size. However, the pellets are well-sintered and grains are in good contact with each other. The EDX study also confirmed the composition of the materials.

SrGeO₃ was modified to contain various Ge analogues to determine the effects on σₒ. B could be substituted for Ge, but not Mg or Al. SrGe₁₋ₓBₓO_{3-0.5x} yielded σₒ of 1.74×10⁻⁵ S/cm, similar to that of SrGe_{0.8}B_{0.2}O_{2.9} (1.12×10⁻⁵ S/cm) for nominal SrGeO₃ at 800° C. In contrast, substitution of a large K⁺ ion for Sr²⁺ in a material with the general formula Sr₁₋ₓKₓGeO_{3-0.5x} in the range 0≦x≦0.25 showed that σₒ varied systematically with x and was superior to σₒ in material that was not substituted for Sr. σₒ in this example reached a maximum σₒ>10⁻² S/cm by 700° C. where x was 0.15. Substitution of K⁺ in SrSiO₃ also resulted in a linear increase of oxide-ion conductivity with maximum conductivity with x=0.2. In Sr₁₋ₓKₓSi_{1-y}Ge_{y}O_{3-0.5x}, Ge substitution on the Si site further improved the oxide ion conductivity and Sr_{0.8}K_{0.2}Si_{0.5}Ge_{0.5}O_{2.9} showed a σₒ˜10⁻² S/cm by 625° C. Substitution of Na⁺ in SrSiO₃ resulted in much improvement in oxide-ion conductivity with a linear increase of the logarithm of oxide-ion conductivity attaining a maximum conductivity of σₒ˜10⁻² S/cm by 525° C. with x=0.4.

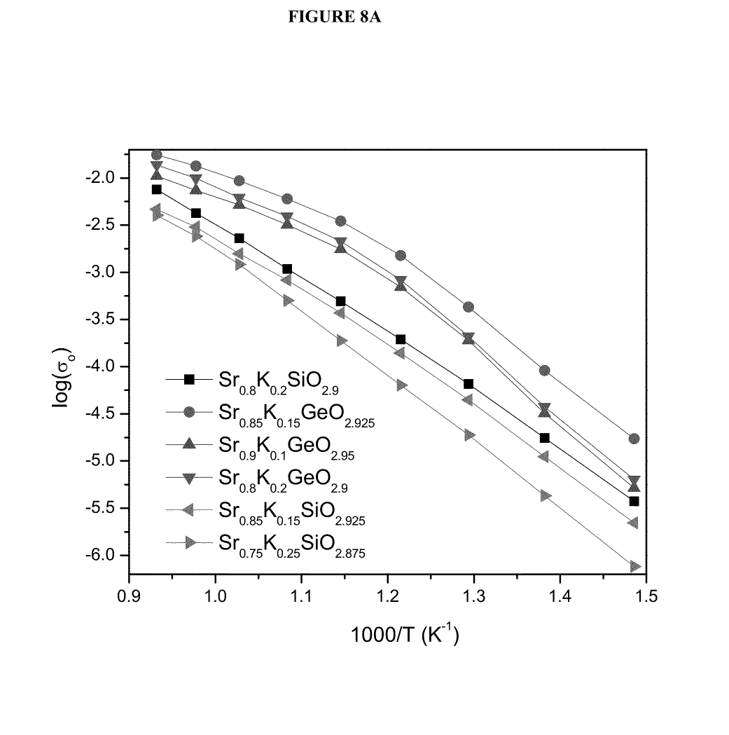

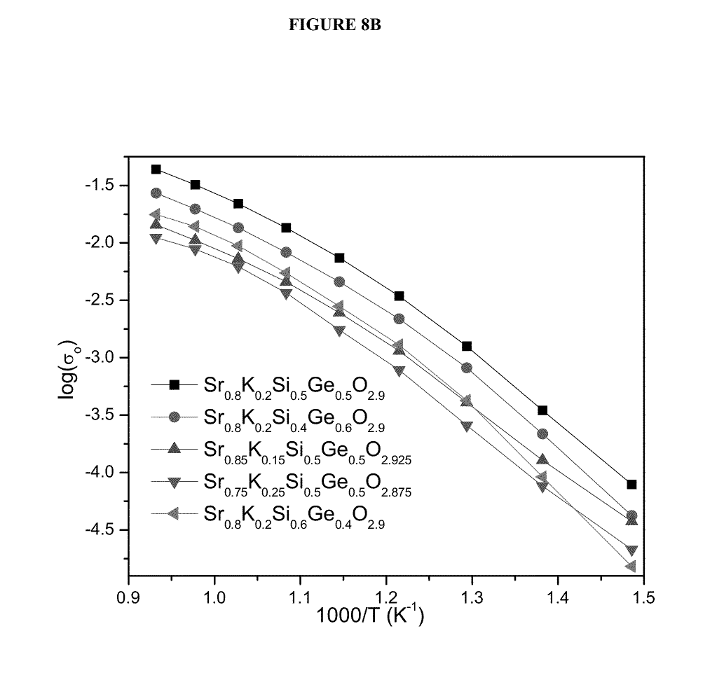

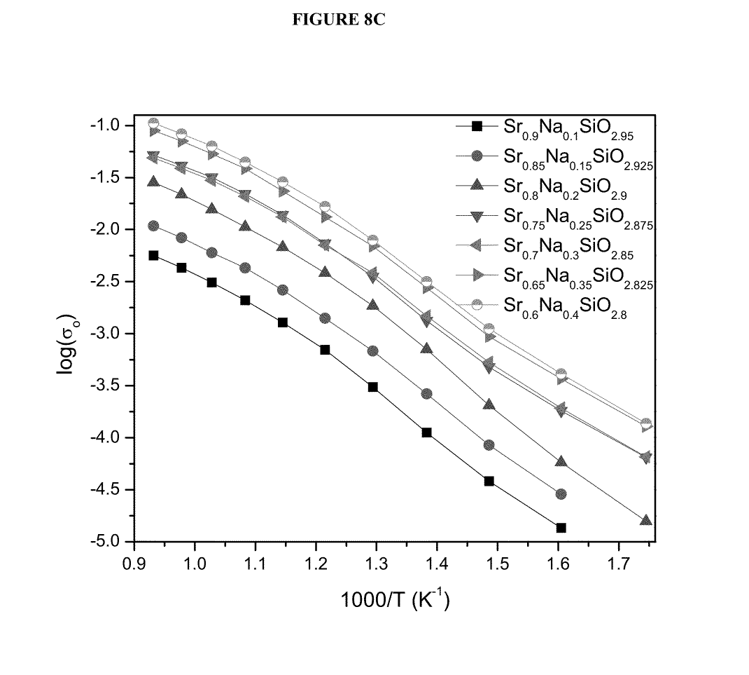

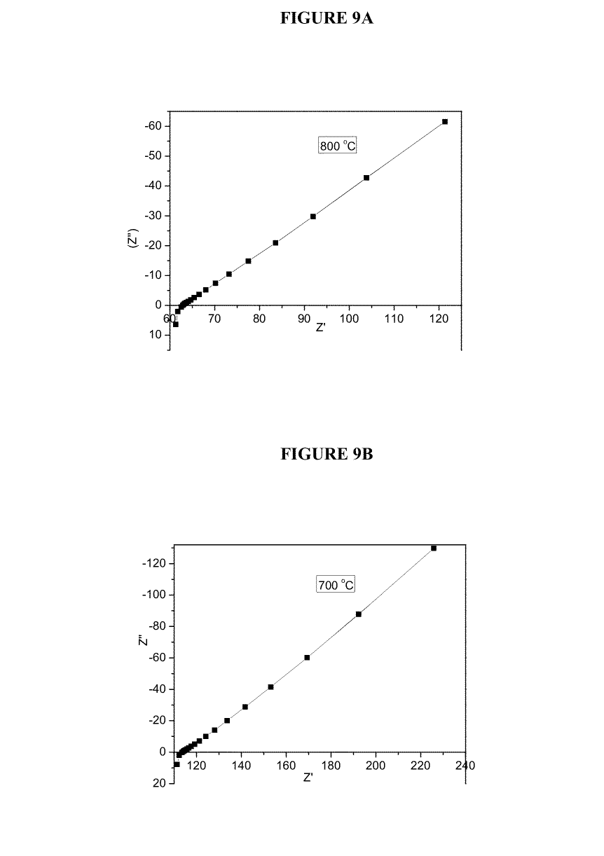

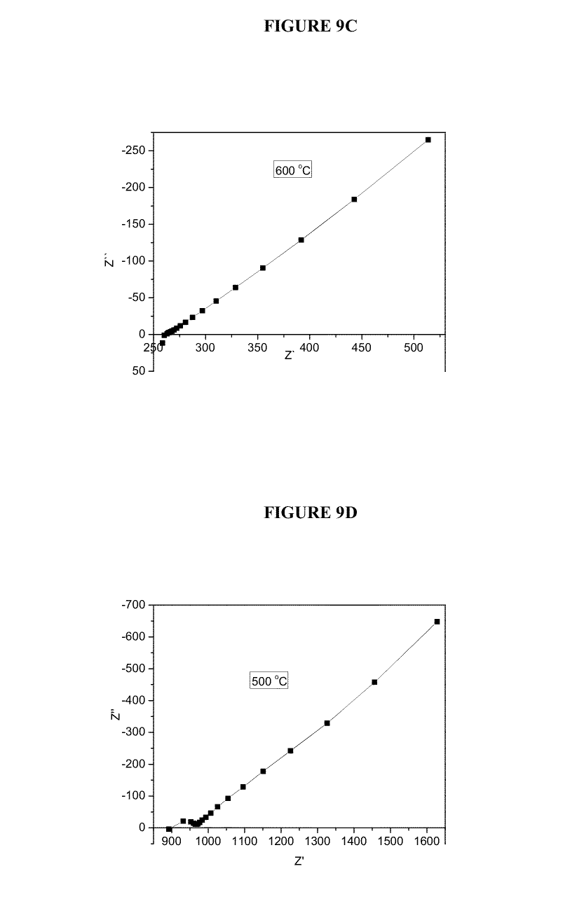

Arrhenius plots (log σₒ vs.1000/T) for materials with the general formula Sr₁₋ₓKₓSi_{1-y}Ge_{y}O_{3-0.5x} are shown in FIG. 8A and FIG. 8B. Two slopes can be seen in each figure showing two different activation energies for oxide-ion conduction in the low-temperature and high-temperature regions. The samples containing Ge and no Si gave a maximum σₒ with x=0.15 and exhibited a broad transition, apparently in the number of long-range-mobile oxide ions, over the temperature range from 600° C. to 650° C. Sr_{0.85}K_{0.15}GeO_{2.925} showed σₒ>10⁻² S/cm by 700° C. Sr_{0.8}K_{0.2}Si_{0.5}Ge_{0.5}O_{2.9} also shows a transition similar to that of Sr_{0.85}K_{0.15}GeO_{2.925} and attains an oxide-ion conductivity σₒ˜10⁻² S/cm by 625° C. because the transition occurs at a lower temperature. The activation energy for Sr_{0.8}K_{0.2}Si_{0.5}Ge_{0.5}O_{2.9} was found to be 0.67 eV in the high-temperature region and 1.16 eV in the low-temperature region. Sr_{0.6}Na_{0.4}SiO_{2.8} (FIG. 8C) also shows a transition similar to that of Sr_{0.85}K_{0.15}GeO_{2.925} and attains an oxide-ion conductivity σₒ˜10⁻² S/cm by 525° C. because the transition occurs at a lower temperature. The activation energy for Sr_{0.6}Na_{0.4}SiO_{2.8} was found to be 0.49 eV in the high-temperature region and 0.77 eV in the low-temperature region. σₒ for Sr₁₋ₓAₓSi_{1-y}Ge_{y}O_{3-0.5x} at different temperatures are provided in TABLES 3 and 4. Activation energies are provided in TABLE 5. A complex impedance spectrum of Sr_{0.8}K_{0.2}Si_{0.5}Ge_{0.5}O_{2.9} at different temperatures is shown in FIG. 9.

TABLE 3
O²⁻ Conductivity (σₒ) of Sr₁₋ₓAₓSi₁₋ₓGeₓO_{3-0.5x} at 550° C.,
600° C., 625° C., and 650° C.

| | Conductivity(S/cm) | | | |
|---|---|---|---|---|
| Compound | 550° C. | 600° C. | 625° C. | 650° C. |
| Sr_{0.9}K_{0.1}GeO_{2.95} | | 1.75 × 10⁻³ | | 3.18 × 10⁻³ |
| Sr_{0.85}K_{0.15}GeO_{2.925} | | 3.5 × 10⁻³ | 4.63 × 10⁻³ | 6.01 × 10⁻³ |
| Sr_{0.8}K_{0.2}GeO_{2.9} | | 2.13 × 10⁻³ | 2.87 × 10⁻³ | 3.92 × 10⁻³ |
| Sr_{0.85}K_{0.15}SiO_{2.925} | | 3.69 × 10⁻⁴ | | 8.26 × 10⁻⁴ |
| Sr_{0.8}K_{0.2}SiO_{2.9} | | 4.94 × 10⁻⁴ | | 1.09 × 10⁻³ |
| Sr_{0.75}K_{0.25}SiO_{2.875} | | 1.89 × 10⁻⁴ | | 5.01 × 10⁻⁴ |
| Sr_{0.8}K_{0.2}Si_{0.5}Ge_{0.5}O_{2.9} | | 7.41 × 10⁻³ | 1.04 × 10⁻² | 1.36 × 10⁻² |
| Sr_{0.8}K_{0.2}Si_{0.6}Ge_{0.4}O_{2.9} | | 2.79 × 10⁻³ | 4.38 × 10⁻³ | 5.48 × 10⁻³ |
| Sr_{0.8}K_{0.2}Si_{0.4}Ge_{0.6}O_{2.9} | | 4.57 × 10⁻³ | 7.64 × 10⁻³ | 8.26 × 10⁻³ |
| Sr_{0.75}K_{0.25}Si_{0.5}Ge_{0.5}O_{2.875} | | 1.74 × 10⁻³ | 2.52 × 10⁻³ | 3.66 × 10⁻³ |
| Sr_{0.85}K_{0.15}Si_{0.5}Ge_{0.5}O_{2.925} | | 2.46 × 10⁻³ | 3.37 × 10⁻³ | 4.57 × 10⁻³ |
| Sr_{0.9}Na_{0.1}SiO_{2.95} | 6.97 × 10⁻⁴ | 1.28 × 10⁻³ | | 2.09 × 10⁻³ |
| Sr_{0.85}Na_{0.15}SiO_{2.925} | 1.4 × 10⁻³ | 2.62 × 10⁻³ | | 4.28 × 10⁻³ |
| Sr_{0.8}Na_{0.2}SiO_{2.9} | 3.83 × 10⁻³ | 6.78 × 10⁻³ | | 1.06 × 10⁻² |
| Sr_{0.75}Na_{0.25}SiO_{2.875} | 7.36 × 10⁻³ | 1.38 × 10⁻² | | 2.19 × 10⁻² |
| Sr_{0.7}Na_{0.3}SiO_{2.85} | 7.06 × 10⁻³ | 1.32 × 10⁻² | | 2.08 × 10⁻² |
| Sr_{0.65}Na_{0.35}SiO_{2.825} | 1.33 × 10⁻² | 2.34 × 10⁻² | | 3.85 × 10⁻² |
| Sr_{0.6}Na_{0.4}SiO_{2.8} | 1.67 × 10⁻² | 2.88 × 10⁻² | | 4.46 × 10⁻² |

TABLE 4
O²⁻ Conductivity (σₒ) of Sr₁₋ₓAₓSi₁₋ₓGeₓO_{3-0.5x} at 700° C., 750° C.,
and 800° C.

| | Conductivity(S/cm) | | |
|---|---|---|---|
| Compound | 700° C. | 750° C. | 800° C. |
| Sr_{0.9}K_{0.1}GeO_{2.95} | 5.18 × 10⁻³ | 7.53 × 10⁻³ | 1.05 × 10⁻² |
| Sr_{0.8}K_{0.15}GeO_{2.925} | 9.31 × 10⁻³ | 1.33 × 10⁻² | 1.75 × 10⁻² |
| Sr_{0.8}K_{0.2}GeO_{2.9} | 6.17 × 10⁻³ | 9.94 × 10⁻³ | 1.37 × 10⁻³ |
| Sr_{0.85}K_{0.15}SiO_{2.925} | 1.58 × 10⁻³ | 3.01 × 10⁻³ | 4.65 × 10⁻³ |
| Sr_{0.8}K_{0.2}SiO_{2.9} | 2.29 × 10⁻³ | 4.24 × 10⁻³ | 7.54 × 10⁻³ |
| Sr_{0.75}K_{0.25}SiO_{2.875} | 1.21 × 10⁻³ | 2.41 × 10⁻³ | 4.01 × 10⁻³ |
| Sr_{0.8}K_{0.2}Si_{0.5}Ge_{0.5}O_{2.9} | 2.2 × 10⁻² | 3.21 × 10⁻² | 4.38 × 10⁻² |
| Sr_{0.8}K_{0.2}Si_{0.6}Ge_{0.4}O_{2.9} | 9.41 × 10⁻³ | 1.39 × 10⁻² | 1.77 × 10⁻² |
| Sr_{0.8}K_{0.2}Si_{0.4}Ge_{0.6}O_{2.9} | 1.35 × 10⁻³ | 1.96 × 10⁻² | 2.74 × 10⁻² |
| Sr_{0.75}K_{0.25}Si_{0.5}Ge_{0.5}O_{2.875} | 6.22 × 10⁻³ | 8.8 × 10⁻³ | 1.11 × 10⁻² |
| Sr_{0.85}K_{0.15}Si_{0.5}Ge_{0.5}O_{2.925} | 7.26 × 10⁻³ | 1.5 × 10⁻² | 1.44 × 10⁻³ |
| Sr_{0.9}Na_{0.1}SiO_{2.95} | 3.11 × 10⁻³ | 4.29 × 10⁻³ | 5.64 × 10⁻³ |
| Sr_{0.85}Na_{0.15}SiO_{2.925} | 5.98 × 10⁻³ | 8.37 × 10⁻³ | 1.08 × 10⁻² |
| Sr_{0.8}Na_{0.2}SiO_{2.9} | 1.56 × 10⁻² | 2.18 × 10⁻² | 2.84 × 10⁻² |
| Sr_{0.75}Na_{0.25}SiO_{2.875} | 3.17 × 10⁻² | 4.1 × 10⁻² | 5.2 × 10⁻² |
| Sr_{0.7}Na_{0.3}SiO_{2.85} | 3.01 × 10⁻² | 3.88 × 10⁻² | 4.87 × 10⁻² |
| Sr_{0.65}Na_{0.35}SiO_{2.825} | 5.34 × 10⁻² | 7.07 × 10⁻² | 8.95 × 10⁻² |
| Sr_{0.6}Na_{0.4}SiO_{2.8} | 6.33 × 10⁻² | 8.33 × 10⁻² | 0.1055 |

TABLE 5
Activation Energy of of Sr₁₋ₓAₓSi₁₋ₓGeₓO_{3-0.5x}

| | Activation energy (eV) | |
|---|---|---|
| | High | Low |
| Compound | temperature region | temperature region |
| Sr_{0.85}K_{0.15}GeO_{2.925} | 0.66 | 1.43 |
| Sr_{0.8}K_{0.2}SiO_{2.9} | 1.1 | 1.26 |
| Sr_{0.8}K_{0.2}Si_{0.5}Ge_{0.5}O_{2.9} | 0.67 | 1.16 |
| Sr_{0.8}K_{0.2}Si_{0.6}Ge_{0.4}O_{2.9} | 0.68 | 1.26 |
| Sr_{0.85}K_{0.15}Si_{0.5}Ge_{0.5}O_{2.925} | 0.71 | 1.19 |
| Sr_{0.9}Na_{0.1}SiO_{2.95} | 0.57 | 0.88 |
| Sr_{0.85}Na_{0.15}SiO_{2.925} | 0.53 | 0.87 |
| Sr_{0.8}Na_{0.2}SiO_{2.9} | 0.56 | 0.91 |
| Sr_{0.75}Na_{0.25}SiO_{2.875} | 0.44 | 0.76 |
| Sr_{0.7}Na_{0.3}SiO_{2.85} | 0.44 | 0.78 |
| Sr_{0.65}Na_{0.35}SiO_{2.825} | 0.48 | 0.76 |

Although only exemplary embodiments of the invention are specifically described above, it will be appreciated that modifications and variations of these examples are possible without departing from the spirit and intended scope of the invention. For example, throughout the specification particular measurements are given. It would be understood by one of ordinary skill in the art that in many instances, particularly outside of the examples, other values similar to, but not exactly the same as the given measurements may be equivalent and may also be encompassed by the present invention.

1. A fuel cell containing a solid electrolyte comprising an electrolyte material with the general formula Sr₁₋ₓAₓSi_{1-y}Ge_{y}O_{3-0.5x},
wherein A is K, Na, or a mixture thereof, and
wherein 0≦y≦1 and 0≦x≦0.4.

2. The fuel cell of claim 1, wherein 0≦y≦0.5.

3. The fuel cell of claim 1, wherein A is K, 0≦y≦0.1, and 0≦x≦0.3.

4. The fuel cell of claim 1, wherein A is K, 0.9≦y≦1 and 0≦x≦0.25.

5. The fuel cell of claim 1, wherein A is Na and 0≦x≦0.4.

6. The fuel cell of claim 1, wherein the material is in the form of a single-phase crystalline solid having a monoclinic crystal structure.

7. The fuel cell of claim 1, wherein the electrolyte material has an oxide-ion conductivity (σₒ) greater than or equal to 10⁻² S/cm at a temperature of at least 500° C.

8. The fuel cell of claim 1, wherein the electrolyte material is in the form of a porous solid having connected grains.

9. The fuel cell of claim 8, wherein the grains are between 2 μm and 10 μm in size.

10. The fuel cell of claim 1, wherein the solid electrolyte is in the form of a planar or tubular membrane.

11. The fuel cell of claim 1, further comprising an anode containing a catalytic material operable to catalyze the formation of adsorbed hydrogen and carbon from hydrogen gas (H₂) or a hydrocarbon.

12. The fuel cell of claim 1, further comprising a cathode containing a catalytic material operable to catalyze the formation of absorbed oxide ions (O²⁻) from oxygen gas (O₂).

13. A planar or tubular membrane comprising a material with the general formula Sr₁₋ₓAₓSi_{1-y}Ge_{y}O_{3-0.5x},
wherein A is K, Na, or a mixture thereof,
wherein 0≦y≦1 and 0≦x≦0.4,
wherein the material is in the form of a single-phase polycrystalline solid having a monoclinic crystal structure, wherein the material has an oxide ion conductivity (σₒ) greater than or equal to 10⁻² S/cm at a temperature of at least 500° C., and
wherein the membrane is electrically insulating.

14. The membrane of claim 13, wherein the material is in the form of a ceramic with connected grains that contain pores.

15. The membrane of claim 13, further comprising a non-electrolyte material.

16. An oxygen sensor comprising a material with the general formula Sr₁₋ₓAₓSi_{1-y}Ge_{y}O_{3-0.5x},
wherein A is K, Na, or a mixture thereof,
wherein 0≦y≦1 and 0≦x≦0.4,
and wherein the material is in the form of a single phase crystalline solid having a monoclinic crystal structure.

17. The oxygen sensor of claim 16, wherein the material has an oxide ion conductivity (σₒ) greater than or equal to 10⁻² S/cm at a temperature of at least 500° C.

18. An oxygen separation membrane comprising a material with the general formula Sr₁₋ₓAₓSi_{1-y}Ge_{y}O_{3-0.5x},
wherein A is K, Na, or a mixture thereof,
wherein 0≦y≦1 and 0≦x≦0.4, and
wherein the material is in the form of a single phase crystalline solid having a monoclinic crystal structure.

19. The oxygen separation membrane of claim 18, wherein the material has an oxide ion conductivity (σₒ) greater than or equal to 10⁻² S/cm at a temperature of at least 500° C.

20. A material with the general formula Sr₁₋ₓKₓSi_{1-y}Ge_{y}O_{3-0.5x}, wherein 0≦y≦1 and 0≦x≦0.3,
wherein the material is in the form of a single-phase polycrystalline solid having a monoclinic crystal structure, and
wherein the material is operable to catalyze oxidation of an olefin.

21. The catalyst of claim 20, wherein the material has an oxide ion conductivity (σₒ) greater than or equal to 10⁻² S/cm at a temperature of at least 500° C.

22. A regenerative fuel cell or reverse fuel cell (RFC) comprising a material with the general formula Sr₁₋ₓAₓSi_{1-y}Ge_{y}O_{3-0.5x}, wherein A is K, Na, or a mixture thereof,
wherein 0≦y≦1 and 0≦x≦0.4, and
wherein the material is in the form of a single-phase crystalline solid having a monoclinic crystal structure.

23. The catalyst of claim 22, wherein the material has an oxide-ion conductivity (σₒ) greater than or equal to 10⁻² S/cm at a temperature of at least 500° C.
